(19) United States
(12) Patent Application Publication
(10) Pub. No.: US 2026/0054996 A1
(43) Pub. Date: Feb. 26, 2026

(54) CARBON SUPPORT WITH TAILORED POROSITY

(71) Applicant: Robert Bosch Gmbh, Stuttgart (DE)

(72) Inventors: Karim GADELRAB, Watertown, MA (US); Jonathan BRAATEN, Sunnyvale, CA (US); Bjoern STUEHMEIER, Santa Clara, CA (US); Lei CHENG, San Jose, CA (US); Nicola MOLINARI, Somerville, MA (US); Shirin MEHRAZI, San Jose, CA (US)

(21) Appl. No.: 18/813,457

(22) Filed: Aug. 23, 2024

(51) Int. Cl. C01B 32/342; C01B 32/354; C08G 77/442; C25B 11/065; H01M 4/90; H01M 8/10

(52) U.S. Cl. CPC C01B 32/342; C01B 32/354; C08G 77/442; C25B 11/065; H01M 4/9083; C01P 2006/16; H01M 2008/1095

(57) ABSTRACT

A method of mesoporous carbon support production includes providing an active silica template from a self-assembling block copolymer (BCP) in a solution, the BCP including a diblock copolymer of polydimethylsiloxane (PDMS) as a majority block and a hydrocarbon polymer as a minority block in a predetermined volume fraction, the BCP being in a form of nanodroplets, drying and annealing the nanodroplets, ashing away the hydrocarbon polymer of the minority block to obtain the active silica template, applying a carbon precursor onto the active silica template, and removing the active silica template to obtain a mesoporous carbon support as a reverse image of the template.

### TECHNICAL FIELD

The present disclosure relates to carbon structures for fuel cell electrocatalyst support, the structures having tailored porosity and a method of producing the same.

### BACKGROUND

Hydrogen technology such as fuel cells and electrolyzers are becoming increasingly popular due to their ability to produce and store clean energy. Yet many challenges remain and pose a hurdle to their large-scale production. Besides the harsh environment of the fuel cells and electrolyzers resulting in material choice challenges, degradation of the components such as the catalysts and the membranes need to be resolved as the degradation affects efficiency of the hydrogen devices. Likewise, functional reliability and fabrication economics need to be improved.

### SUMMARY

In one embodiment, a method of mesoporous carbon support production is disclosed. The method may include providing an active silica template from a self-assembling block copolymer (BCP) in a solution, the BCP including a diblock copolymer of polydimethylsiloxane (PDMS) as a majority block and a hydrocarbon polymer as a minority block in a predetermined volume fraction, the BCP being in a form of nanodroplets. The method may also include drying and annealing the nanodroplets. The method may include ashing away the hydrocarbon polymer of the minority block to obtain the active silica template. The method may further include applying a carbon precursor onto the active silica template. The method may include removing the active silica template to obtain a mesoporous carbon support as a reverse image of the template. The predetermined volume fraction may be about 60-90:10-40 vol. % majority:minority block. The predetermined volume fraction may be at least about 75 vol. % of the majority block. The mesoporous carbon support may have a narrow pore size distribution of only 1-3 pore sizes, at least one size larger than about 40 nm. The method may also include graphitizing the mesoporous carbon support. The method may also include infusing the PDMS with one or more homopolymers. The minority block may include polystyrene.

In one or more embodiments, a mesoporous carbon support produced by the described method is disclosed. The mesoporous carbon support may have an ordered rod-like interconnected structure with a narrow pore size distribution of 1-3 pore sizes and including pores with a diameter greater than about 40 nm.

In another embodiment, an active silica template precursor is disclosed. The precursor may include a plurality of a self-assembling block copolymer (BCP) nanodroplets in solution, the nanodroplets including a diblock copolymer of polydimethylsiloxane (PDMS) as a majority block and a hydrocarbon polymer as a minority block, the majority:minority block being in a predetermined volume fraction. The predetermined volume fraction may be about 60-90:10-40 vol. % majority:minority block. The predetermined volume fraction may be at least about 75 vol. % of the majority block. The majority block may include one or more infused homopolymers. The hydrocarbon polymer may include polystyrene.

In an alternative embodiment, a method of templating mesoporous carbon support is disclosed. The method may include, based on a predetermined pore size distribution of the carbon support, preparing a template in solution including a self-assembling block copolymer (BCP) nanodroplets including a polydimethylsiloxane (PDMS) majority block and a hydrocarbon polymer minority block in a predetermined volume fraction favoring the majority block. The method may also include ashing away the hydrocarbon polymer of the minority block to obtain the template. The method may further include applying a carbon precursor onto the template. The method may also include removing the template to obtain the mesoporous carbon support with the predetermined pore size distribution and having at least one pore size greater than about 40 nm. The template may resemble a porous glass bead. The predetermined volume fraction may be about 40-90:10-60 vol. % majority:minority block. The predetermined volume fraction may be at least about 75 vol. % of the majority block. The hydrocarbon polymer minority block may include polystyrene. The method may also include graphitizing the mesoporous carbon support. The nanodroplets may be spherical with internal structure of intricate microphase separated networks of the hydrocarbon polymer minority block.

### BRIEF DESCRIPTION OF THE DRAWINGS

FIG. 1 shows a schematic of a non-limiting example proton exchange membrane fuel cell;

FIGS. 2A-2E show images of non-limiting example structures generated from block copolymer (BCP) self-assembly according to one or more embodiments disclosed herein; and

FIGS. 3A and 3B show non-limiting example active silica templates according to one or more embodiments disclosed herein.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt. % is based on the total weight of the substrate and the vol. % is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/−5% of the value. As one example, the phrase “about 100” denotes a range of 100+/−5, i.e. the range from 95 to 105. Generally, when the term “about” is used, it can be expected that similar results or effects according to the disclosure can be obtained within a range of +/−5% of the indicated value. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . , 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Chemical and electrochemical systems utilizing hydrogen as a fuel source are considered the energy systems of the future either in direct hydrogen combustion engines or fuel cells. These hydrogen-producing devices are becoming increasingly popular due to their ability to produce clean energy. The systems may include fuel cells, electrolysis cells or electrolyzers, and battery cells. Fuel cells, or electrochemical cells, that convert chemical energy of a fuel (e.g. H₂) and an oxidizing agent into electricity through a pair of electrochemical half (redox) reactions, have become an increasingly popular hydrogen-fuel-generating technology. Fuel cells are now a promising alternative transportation technology capable of operating without emissions of either toxins or green-house gases. An electrolyzer is an electrochemical device designed to convert electricity and water into hydrogen and oxygen, which may be in turn used to store energy. The electrolyzer utilizes electrolysis for hydrogen production. Besides fuel cells, the electrolyzer may be utilized in other applications including industrial, residential, and military applications and technologies focused on energy storage such as electrical grid stabilization from dynamic electrical sources including wind turbines, solar cells, or localized hydrogen production.

Non-limiting examples of fuel cells include proton exchange membrane fuel cells (PEMFCs). Utilizing an electrochemical reaction of H₂ and O₂ gases, PEMFCs provide a practical energy efficiency of over 60% with H₂O as the only product. The fast diffusion of H-ions enables functional operation of the PEMFC at a relatively low temperature of about 100° C. In contrast, solid oxide fuel cells and molten carbonate fuel cells operate at about 600° C. and above.

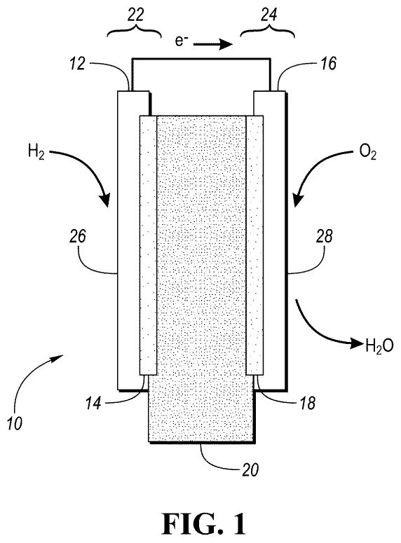

A non-limiting example of a fuel cell, a PEMFC is depicted in FIG. 1A. As shown in FIG. 1, PEMFC 110 includes anode catalyst support 112 coated with anode catalyst layer 114 formed of an anode catalyst material and cathode catalyst support 16 coated with cathode catalyst layer 118 formed of a cathode catalyst material. Polymer electrolyte material (PEM) 120 extends between anode catalyst support 112 and cathode catalyst support 116. The cathode catalyst material may be dispersed at an interface of PEM 120 and a current collector (not shown) supported by cathode catalyst support 118. The current collector may be a porous carbon current collector. Anode catalyst layer 114 is positioned between anode catalyst support 112 and PEM 120. Cathode catalyst layer 118 is positioned between cathode catalyst support 116 and PEM 120. Anode 122 may generally refer to anode catalyst support 112 and anode catalyst layer 114. Cathode 124 may generally refer to cathode catalyst support 116, cathode catalyst layer 118, and the current collector (not shown). PEMFC 110 also includes first and second gas diffusion layers (GDLs) (not shown). First GDL is adjacent outer surface 126 of anode catalyst support 112 and second GDL is adjacent outer surface 128 of cathode catalyst support 116.

Despite the benefits of PEMFCs, their high production price and relatively poor durability are limiting their application in energy plants and more affordable transportation technologies. For example, the platinum (Pt)/carbon (C) electrocatalysts in PEMFC cathodes cost at least half of the production price of a PEMFC, while the electrochemically active surface area (ECSA) of a Pt catalyst degrades severely (e.g., 50% or greater) during cycling.

Optimizing the microstructure of the catalyst support is a promising step for improving the durability of a PEMFC and decreasing the cost thereof. Various forms of carbon have been explored and tested for PEMFC applications including the catalyst support material. While many types of the support are carbon-based, research has confirmed that differences in the carbon structure, morphology, allotropic form, etc. influence properties and capabilities of the support. Hence, not only the type of carbon, but also production conditions and changes influence applicability of the carbon for certain applications. For example, numerous ordered mesoporous carbon (OMC) and colloid imprint carbon (CIC) structures have been identified and can significantly differ in their properties such as in conductivity, elasticity, tensile strength, thermal conductivity, etc.

Optimization of the carbon support for a Pt catalyst is a promising step for improving the durability of a PEMFC and decreasing the cost thereof. For example, mesoporous carbon support materials have been found to provide a relatively large surface area which promote multiple Pt nucleation sites and overall smaller average Pt particle size. In tuning porosity size and connectivity, OMC and CIC have stood out as promising synthetic approaches to gain control over the final carbon support structure. The OMC is a flexible, open rigid structure, a 3D nanostructured porous carbon material with uniform pore size. The OMC has a regular, honeycomb-like configuration including a plurality of adjacent tubes oriented parallel to one another.

The OMCs for PEMFC applications have been prepared using ordered mesoporous silica (SBA-15) as a template for OMC synthesis. For example, pores of SBA-15 were filled with furfuryl alcohol and the sample was heated to 80° C. to induce polymerization of furfuryl alcohol on the acidic sites on the SBA-15 walls. The remaining furfuryl alcohol was then removed under vacuum and the carbon/silica composite was carbonized, followed by removal of the SBA-15 template through refluxing in NaOH. The resulting OMC was composed of hollow tubes with a pore diameter of 5.9 nm, and 4.2 nm pores between adjacent tubes. While the process seemed promising, the oxygen reduction reaction (ORR) occurring at the Pt/OMC catalysts became transport-limited at high current densities as reactants and products need to rapidly transport to and from active Pt sites deep inside the OMC pores. Specifically, the Nafion™ proton conductor may not be able to access the tight pores and connect with the Pt NPs, likely then resulting in proton transport limited currents.

In 2001, Li et al., reported a different approach to mesoporous carbon design, allowing for control of both pore diameter and length. This synthesis was based on the unique physical properties of a naphthalene-based mesophase pitch precursor, which is a polycyclic aromatic hydrocarbon (PAH) and a common by-product of the petroleum industry. The PAHs interact through long-range London dispersion forces and arrange in an ordered, liquid crystalline structure. A synthetic naphthalene-based mesophase pitch (Mitsubishi AR pitch) was chosen by Li et al., as petroleum-based pitches often contain sulfur impurities. The reported softening range of this pitch varied, with the lower and upper temperatures generally falling between 230° C. and 350° C.

The process generated a porous CIC powder with pore diameters equal to the size of the SiO₂ colloids that were used, and pore lengths controlled by imprinting temperature. While CIC provided good control over pore size and depth, further analysis discovered that the walls were excessively thin due to the strong packing of silica spheres on the carbon surface which negatively impacted electronic transport and resulted in an overall reduction of current density. Furthermore, there was no clear evidence on the state of graphitization of the final carbon pores produced by CIC.

Hence, there is a need to develop alternative mesoporous carbon-based materials suitable for mass transport management at high current densities.

In one or more embodiments, a method of preparing a mesoporous carbon support superior to the OMC and CIC described herein is disclosed. The method may include one or more steps of forming carbon support structures. The carbon structures may be formed using a template-guided synthesis. The method may include the steps of creating a template, applying a carbon precursor into the template to form the carbon structure, annealing, removing the template, and graphitizing the carbon structure.

The method may include utilizing BCPs for templating. The BCPs include two or more chemically distinct and frequently immiscible blocks that are covalently bound together. The BCPs thus include at least a majority block and at least one minority block that decomposes during the process. The BCPs may include two types of blocks such as AB diblock copolymer or additional blocks such as ABC triblock copolymers. The majority block or matrix may include polydimethylsiloxane (PDMS) and the minority block may include a hydrocarbon such as polystyrene (PS), polymethylmethacrylate (PMMA), polylactic acid (PLA), the like, or their combination. PDMS is a synthetic polymer in the silicone class of polymers containing a Si—O backbone.

The method employs BCPs as BCP self-assembly may result in formation of ordered structures in a number of various configurations, depending on the type and volume of the majority and minority blocks. Self-assembly relates to the BCP ability to self-organize into a morphology under certain circumstances, similar to self-formation of small-molecule surfactants. Additionally, the BCP pore size is in the relevant range of Nafion™ accessibility of about 40 nm. Additionally still, the domain or pore size is proportional to the BCP molecular weight. Hence, pores can be tuned to optimize performance based on the selected BCP.

The method may utilize BCP self-assembly in solution, which forms the template precursor. The method may include providing nanodroplets of BCP to form the template. The droplets may be formed using spraying or sonication of the BCP in a solvent. In a non-limiting example, the solvent may be water, organic polar solvents such as heptane, toluene, tetrahydrofuran (THF). The droplets may be spherical with internal structure of intricate microphase separated networks of the minority polymer. Among other parameters, the internal structure of the droplets is a function of the block volume fraction (how much of each block is along the single chain).

The method may thus include tailoring the template structure by selecting the volume of each fraction or the amount of the majority block, minority block, or both to generate carbon structures having (a) a predetermined porous structure, (b) a predetermined narrow pore size distribution, (c) a predetermined pore diameter of the carbon structure, or a combination thereof.

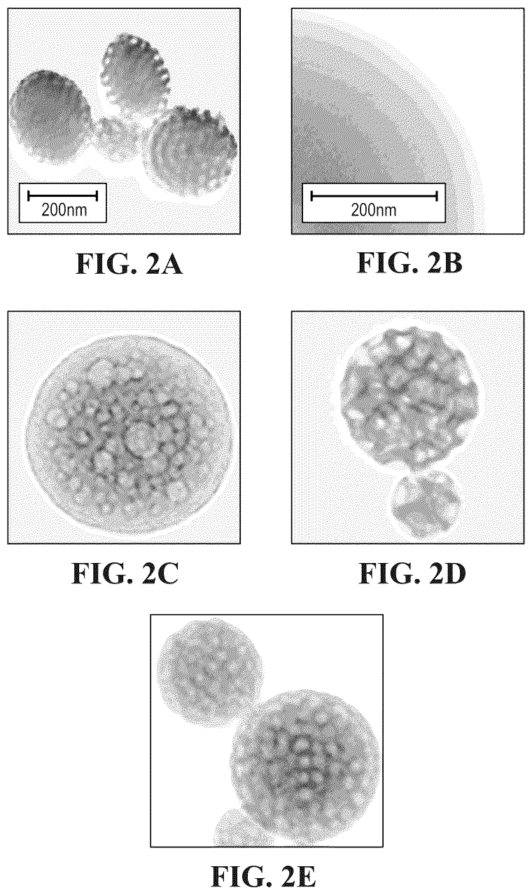

The predetermined porous structure may include predominantly spherical structures. The spherical structures may have regular or irregular shape, elongations, protrusions from the surface such as bumps, irregularities, peaks, valleys, the like, or a combination thereof. The protrusions may be concentric, regularly or irregularly spaced apart, having the same or different diameter, or a combination thereof. Non-limiting examples of the structures generated from the BCP self-assembly and disclosed tailoring are shown in FIGS. 2A-2E. As is described further, the carbon-based portions of the structures are etched away or ashed away (carbon burning in a strongly oxidizing environment) by oxygen plasma and the majority block polymer is transformed into an active silica template.

The predetermined pore size distribution of the resulting carbon structure may be a very narrow pore size distribution of about 1 to 6, 2 to 5, or 3 to 4 pore sizes. The size may be within the pore diameter of about 30 to 50, 32 to 48, or 35 to 45 nm. The method may include adjusting the block volume fraction to tailor the template to include predominantly or only specific pore sizes, for example within the disclosed pore diameter range. In a non-limiting example, the target pore diameters may be two sizes, specifically about 30 nm and about 45 nm. In another non-limiting example, the target pore diameters may be three sizes, specifically about 40 nm, 42 nm, and about 48 nm. Since the majority block's wall thickness eventually becomes the pore diameter of the carbon structure, adjusting the volume fraction of the majority block:minority block influences the wall thickness of the template and in turn the pore diameter and pore size distribution of the carbon structures. The volume fraction may be predetermined. The volume fraction relates to a percentage by volume and expresses a composition of a mixture with a dimensionless quantity. The volume fraction may be determined by dividing the volume of the individual substance by the volume of all of the substances.

The volume fractions of the majority block:minority block may be about, at least about, or at most about 51:49, 55:45, 60:40, 65:35, 70:30, 75:25, 80:20, 85:15, or 90:10 vol %. The method may include providing an equal block proportion resulting in a layered stacking inside the nanodroplet. The equal block proportion may be about 45/55 to 55/45 vol. % (majority block/minority block). Yet, equal proportions, or greater vol. % of the minor block than about 40 vol. %, may result in a lamellar structure which is undesirable. Hence, the method may include minimizing the carbon-based minor block volume to access the interconnected network. The method may include selecting a relatively large disproportion of the block volumes such as about 75 vol. % or greater of the majority block and about 25 vol. % or less of the minority block, resulting in isolated spheres with a golf ball-like or glass-bead surface. In a non-limiting example, the ratio may be about 10-40 minority block: about 60-90 vol % majority block. In another non-limiting example, the ratio may be below about 40 vol. % minority block:above about 60 vol % majority block.

The method may further include incorporating one or more homopolymers of the same chemistry as the block(s), surfactants, or both into the BCP to tune the pore structure and internal structure of the nanodroplets. The homopolymers may infuse into one of the blocks. Adding homopolymers of the same chemistry as the block(s) may swell specific phases and change the local polymer proportions. The method may include adding one or more homopolymers of the majority block only, minority block only, or a combination thereof. The method may include growing the PDMS matrix with one or more homopolymer infusions.

The method may subsequently include drying of the formed droplets, followed by annealing to induce microphase separation and internal structure formation of the template. Annealing may be performed at the glass transition temperature (Tg) of the polymers to reveal the characteristic morphology of the material. Annealing may be performed either thermally under controlled conditions such as inert environment of N₂, Ar, at temperatures of about 100° C., or by solvent vapor annealing in toluene, THF, heptane, or the like.

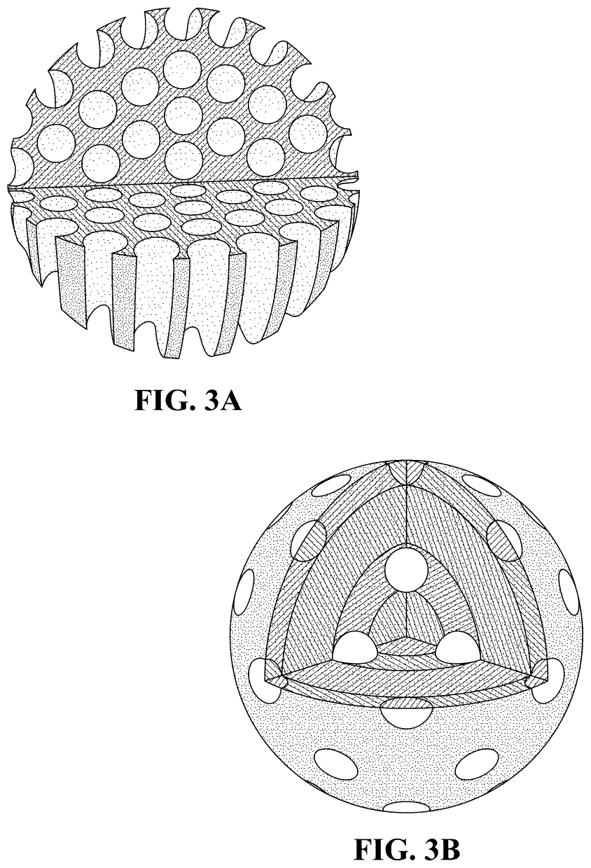

The method further includes using oxygen plasma to etch or ash away the hydrocarbon-based polymer of the minority block, obtaining the structure reveal of the nanodroplets, and the PDMS matrix transformation into an active silica framework of the template. Exposing the self-assembled droplets to oxygen plasma etches or ashes away the carbon-based polymer and transforms the majority block polymer into active silica, resulting in a porous glass bead structure of the template. The structure of the porous glass bead serves as a mold for the negative replication of the carbon structure to be formed. A non-limiting example of the glass bead template is shown in FIGS. 3A and 3B. As can be seen in the FIGS. 3A and 3B, the porous template is depicted in a darker color while the pores into which carbon is to be deposited are shown in a lighter color.

The method may include providing a carbon precursor into the template. The carbon precursor may include an amorphous carbon. The pore volume of the porous silica glass bead framework may be coated, filled, or infused with the carbon precursor. Traditional techniques may be utilized such as polymerization of furfuryl alcohol or polycyclic aromatic hydrocarbon (PAH) to fill the silica pores.

The method may include carbonization followed by removal of the silica framework, for example by refluxing in NaOH. The result is a negatively replicated carbon structure. The carbon structure includes a carbon framework in the footprint of the mold pores while the volume previously occupied by the silicon template translated into the tailored mesopores of the fabricated carbon structure. The carbon structure is a reverse image of the hard template.

The method may also include graphitizing of the formed carbon structure. The graphitizing may include one or more steps including treatment under a high temperature such as annealing.

The method may include adding electrocatalyst by any suitable method such as chemical reduction, electrochemical deposition, chemical vapor deposition, physical deposition such as bombardment of the carbon structure with catalyst particles, or the like.

In one or more embodiments, a graphitized mesoporous carbon support formed by the method disclosed herein is disclosed. The graphitized porous carbon may have a number of advantages over the OMC and CIC described above. For example, the carbon support may have a shallow pore diameter greater than about 40 nm to provide easy access to proton conductors such as Nafion™. The pore diameter may be about 30 to 50, 32 to 48, or 35 to 45 nm. The pore diameter may be about, at least about, or at most about 30, 31, 32, 33, 34, 35, 36, 37, 38, 39, 40, 41, 42, 43, 44, 45, 46, 47, 48, 49, or 50 nm. The porous carbon may also include micropores with a diameter equal to or less than 2 nm. The carbon support may have a very narrow pore size distribution of about 1 to 6, 2 to 5, or 3 to 4 different types of pore sizes. The carbon support may have only 2 or 3 different types of pore diameters.

The carbon support structure may be an ordered structure having symmetrical arrangement, rod-like interconnected configuration.

The carbon support may be a graphitized carbon support to have enhanced support durability and to minimize corrosion.

The carbon support may have a very high surface area in a range of about 500 to 3000, 800 to 2500, or 1000 to 1400 m²/g. The very high surface area may be about, or at least about 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, or 3000 m₂/g.

The carbon support may have a density of about 1-5, 1.2-4.8, or 1.5-4.5 g/cm³. The density may be about, at least about, or at most about 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or 5.0 g/cm³. A non-limiting example density may be about 0.7-3.5, 1.0-300, or 1.5-2.3 g/cm³.

The carbon structure made by the process disclosed herein may be utilized for production of one or more components of a fuel cell such as a PEMFC schematically depicted in FIG. 1. A non-limiting example use of the carbon precursors fabricated according to one or more embodiments disclosed herein may include high surface area carbon applications, carbon support for a catalyst such as Pt in a PEMFC cathode, anode materials, cathode in a water electrolysis system, etc.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of mesoporous carbon support production, the method comprising:
providing an active silica template from a self-assembling block copolymer (BCP) in a solution, the BCP including a diblock copolymer of polydimethylsiloxane (PDMS) as a majority block and a hydrocarbon polymer as a minority block in a predetermined volume fraction, the BCP being in a form of nanodroplets;
drying and annealing the nanodroplets;
ashing away the hydrocarbon polymer of the minority block to obtain the active silica template;
applying a carbon precursor onto the active silica template; and
removing the active silica template to obtain a mesoporous carbon support as a reverse image of the template.

2. The method of claim 1, wherein the predetermined volume fraction is about 60-90:10-40 vol. % majority:minority block.

3. The method of claim 1, wherein the predetermined volume fraction is at least about 75 vol. % of the majority block.

4. The method of claim 1, wherein the mesoporous carbon support has a narrow pore size distribution of only 1-3 pore sizes, at least one size larger than about 40 nm.

5. The method of claim 1, further comprising graphitizing the mesoporous carbon support.

6. The method of claim 1, further comprising infusing the PDMS with one or more homopolymers.

7. The method of claim 1, wherein the minority block includes polystyrene.

8. A mesoporous carbon support produced by the method of claim 1, the mesoporous carbon support having an ordered rod-like interconnected structure with a narrow pore size distribution of 1-3 pore sizes and including pores with a diameter greater than about 40 nm.

9. An active silica template precursor comprising:
a plurality of a self-assembling block copolymer (BCP) nanodroplets in solution, the nanodroplets including a diblock copolymer of polydimethylsiloxane (PDMS) as a majority block and a hydrocarbon polymer as a minority block, the majority:minority block being in a predetermined volume fraction.

10. The template precursor of claim 9, wherein the predetermined volume fraction is about 60-90:10-40 vol. % majority:minority block.

11. The template precursor of claim 9, wherein the predetermined volume fraction may be at least about 75 vol. % of the majority block.

12. The template precursor of claim 9, wherein the majority block includes one or more infused homopolymers.

13. The template precursor of claim 9, wherein the hydrocarbon polymer includes polystyrene.

14. A method of templating mesoporous carbon support, the method comprising:
based on a predetermined pore size distribution of the carbon support,
preparing a template in solution including a self-assembling block copolymer (BCP) nanodroplets including a polydimethylsiloxane (PDMS) majority block and a hydrocarbon polymer minority block in a predetermined volume fraction favoring the majority block;
ashing away the hydrocarbon polymer of the minority block to obtain the template;
applying a carbon precursor onto the template; and
removing the template to obtain the mesoporous carbon support with the predetermined pore size distribution and having at least one pore size greater than about 40 nm.

15. The method of claim 14, wherein the template resembles a porous glass bead.

16. The method of claim 14, wherein the predetermined volume fraction is about 60-90:10-40 vol. % majority:minority block.

17. The method of claim 14, wherein the predetermined volume fraction is at least about 75 vol. % of the majority block.

18. The method of claim 14, wherein the hydrocarbon polymer minority block includes polystyrene.

19. The method of claim 14, further comprising graphitizing the mesoporous carbon support.

20. The method of claim 14, wherein the nanodroplets are spherical with internal structure of intricate microphase separated networks of the hydrocarbon polymer minority block.
